(19) United States
(12) Patent Application Publication
(10) Pub. No.: US 2006/0061561 A1
(43) Pub. Date: Mar. 23, 2006

(54) Image processing device

(75) Inventors: Han-Min Cheng, Taichung (TW); Hsiu-Wen Wang, Keelung (TW)

Correspondence Address: BACON & THOMAS, PLLC, 625 SLATERS LANE, FOURTH FLOOR, ALEXANDRIA, VA, 22314, US

(73) Assignee: Alpha Imaging Technology Corp., Jhubei City (TW)

(21) Appl. No.: 11/229,510

(22) Filed: Sep. 20, 2005

(30) Foreign Application Priority Data
Sep. 20, 2004 (TW) 93128381

(51) Int. Cl. G09G 5/00

(52) U.S. Cl. 345/204

(57) ABSTRACT

An image processing device includes memory and a display panel controller. The memory is used to store digitized image data derived from the image data captured by the image sensor, and the display panel controller is used to process the digitized image data stored in the memory. A portion of the image data captured by the image sensor are directly processed by the display controller and output to the display panel.

This application claims the benefit of Taiwan application Serial No. 93128381, filed Sep. 20, 2004, the subject matter of which is incorporated herein by reference.

### BACKGROUND OF THE INVENTION

1. Field of the Invention

The invention relates to an image processing device and more particularly to an image processing device capable of saving memory space.

2. Description of the Related Art

FIG. 1 is a schematic block diagram showing the structure of a conventional mobile phone. Referring to FIG. 1, the mobile phone 100 includes an image sensor 110, an image processing device 120 and a LCD display panel 130. The image processing device 120 includes memory 122 and a display panel controller 124. In general, the image data Dj captured by the image sensor 110 will be completely digitized and stored in the memory 122. When the image data Dj are to be displayed, the display panel controller 124 will read and transmit the digitized image data Dk from the memory 122 to the display panel 130.

However, with regard to the memory 122, the image processing device 120 usually needs memory 122 enough for storing a frame of image displayed on the display panel 130. As a consequence, the memory space is unable to be effectively saved and the objective of reducing the cost cannot be achieved during the research and development of the image processing device of the mobile phone.

### SUMMARY OF THE INVENTION

It is therefore an object of the invention to provide an image processing device. The image processing device uses minimal memory to store the image data transmitted from the image sensor instead of the memory of a size for storing data corresponding to a frame of image according to the sensor's data receiving rate, the image size, and the display panel controller's image-data transmission rate. Therefore, the memory space is effectively saved and production cost is further reduced.

It is an objective of the invention to provide an image processing device. The image processing device is used in a handheld information processing apparatus. The handheld information processing apparatus includes an image sensor and a display panel. The image sensor is used to sense an image. The image processing device includes memory and a display panel controller. The memory is used to store digitized image data derived from the image data captured by the image sensor. The display panel controller is used to process the digitized image data stored in the memory. A portion of the image data captured by the image sensor are directly processed by the display panel. Therefore, the memory space required is smaller then the image data amount corresponding to a frame of image and thus the cost is reduced effectively.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a block diagram showing the structure of a conventional mobile phone.

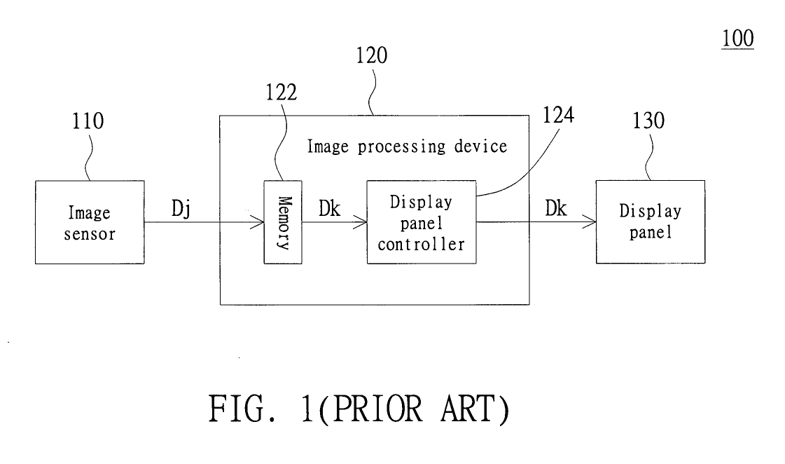

FIG. 2 is a block diagram showing the structure of the mobile phone according to a preferred embodiment of the invention.

### DETAILED DESCRIPTION OF THE INVENTION

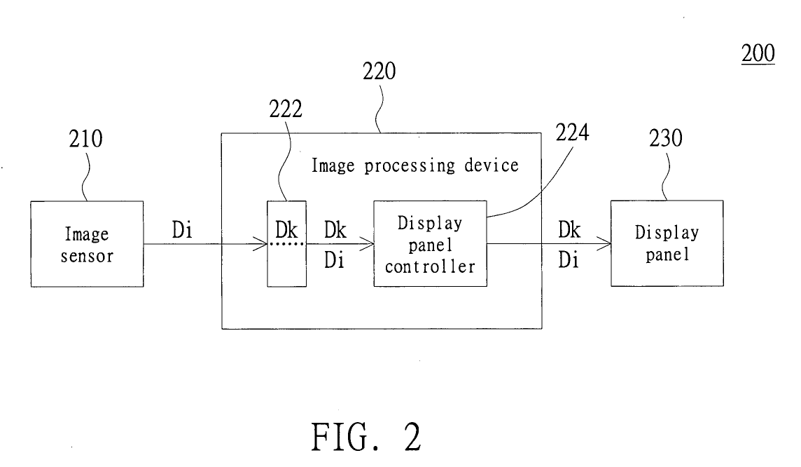

Referring to FIG. 2 is a block diagram illustrating the structure of the mobile phone according to a preferred embodiment of the invention. The mobile phone 200 includes an image sensor 210, an image processing device 220 and a display panel 230. The image processing device 220 includes memory 222 and a display panel controller 224. The image processing device 220 is used to digitize and store the image data Di captured by the image sensor 210 or process and transmit the digitized image data Dk derived from the image data Di to the display panel 230. The memory 222, for example, First In first Out (FIFO) memory, is used to store digitized image data Dk. When the image data Dk are on demand for display, the display panel controller 224 can read, process and then transmit the digitized image data Dk from the memory 222 to the display panel 230.

Unlike the conventional image processing device 120 storing the data corresponding to a frame of image at a time, the image processing device 220 of the invention can receive the image data Di input from the image sensor 210 and directly transmit the image data Di to the display panel 230. That is to say, the image data Di corresponding to a frame of image are not necessary stored in the memory 222 beforehand but are large-proportionally transmitted directly to the display panel 230. The image processing device uses minimal memory space of the memory 222 suitable for storing the image data Dk according to different rates of the sensor 210 inputting data Di, image sizes, and rates of the display panel controller 224 transmitting data Dk. The required memory 222 can be of that size for storing image data Dk corresponding to a line of image, or the memory 222 is even not required at all.

The size of the image on the display panel 230 is supposed to be Lw×Lh (pixel), generally, the specification size of the mobile phone panel is 160×120. The line blanking between data of each line is supposed to be B ns. The time required for transmitting the image data Di corresponding to each pixel displayed on the display panel 230 in from the image sensor 210 is supposed to be X ns. Also, the speed of sending the image data Dk corresponding to each pixel from the display panel controller 224 is supposed to be Y ns. The value of Y in common specification of the mobile phone is 100-300 ns. In the following description, a number of cases are used to illustrate the minimal memory 222 suitable for storing the image data Dk in the image processing device 220 of the invention.

If X>=Y, the display panel controller 224 can transmit the image data Di input from the image sensor 210 directly to the display panel 230 in time. Therefore, no memory 222 is needed for buffer. This is a case of saving the most memory. For example, the pixel rate of a VGA-class sensor having resolution 640×480 and frame rate 15 fps is about (640+160)×480×15=5.76 M pixel per second wherein the 160 pixels are the amount of pixels between each line of image. The sensor 210 inputs 640 points image data Di for each line and picks up one point out of four points to display on the 160×120 panel 230. Therefore, X is 4/5.76 M=694 (ns). However, with regard to the specification of general mobile phone, the time Yns needed for data corresponding to each pixel to be sent from the display panel controller 224 to the display panel 230 is about 200 ns. Obviously, when X>=Y, the image data Di can be processed and transmitted in time to the display panel 224 for display and have no need to be saved in the memory 222 beforehand.

When X<Y and (Lw×X+B)>=(Lw×Y), it represents that the data Di input speed of the sensor 210 is faster than the data Dk output speed of the display panel controller 224. Hence, the memory 222 is needed for buffer. The time (Lw×X+B) required for the image sensor 210 to sent image data Di corresponding to a line of image is longer than the time (Lw×Y) spent by the display panel controller 224 to sent a line of image data Dk to the display panel 230. Accordingly, the maximal amount of memory 222 needed here is of the size capable of storing image data Dk corresponding to one line of image on the display panel 230. Using the VGA sensor having resolution 640×480 and frame rate 15 fps as an example, if the image displayed by the 160×120 display panel 230 is to be enlarged four times, i.e., the image sensor 210 only picks up 160 points among the 640 points of the image data Di and discards the rest 480 points. The time X needed for inputting image data Di corresponding to each pixel is 1/5.76 M=174 (ns), while the display panel controller 224 needs roughly 200 ns (Yns) to send data Dk of each pixel to the display panel 230. Here, X is smaller than Y Moreover, the line blanking time (Bns) between data of each line is roughly 800 ns. Therefore, it takes 160×174+8000=35840 ns for the image sensor 210 to receive one line of image data Di, and 160×200=32000 ns for the image data Dk of one line to be sent to the display panel 230. Obviously, 35840 ns is longer than 32000 ns. Thus, the maximal amount of memory required here is of the size for storing the image data Dk corresponding to one line of image on the display panel 230.

The image processing apparatus disclosed according to the above-mentioned embodiment of the invention has the following advantage. A minimal memory used for storing image data can be achieved as long as the time needed for inputting data corresponding to one line of image acquired from the image sensor plus the line blanking time for the sensor to input data of each line is longer than the time required for the display panel controller to transmit the digitised image data corresponding to one line of image to the display panel. The size of the minimal memory can be the size of the image data corresponding to one line of image or it might even require no memory at all. Therefore, the memory can be saved effectively, and the production cost can be thus reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing device for a handheld information processing apparatus having an image sensor and a display panel, the image processing device comprising:
a memory, for storing digitized image data derived from the image data captured by the image sensor; and
a display panel controller, for processing the digitized image data stored in the memory;
wherein a portion of the image data captured by the image sensor are directly processed by the display panel controller and then output to the display panel.

2. The image processing device according to claim 1, wherein the memory space is smaller than the image data amount corresponding to a frame of image on the display panel.

3. The image processing device according to claim 1, wherein the time required for inputting each of the image data from the image sensor to the image processing device is not less than the time required for outputting each of the image data from the display panel controller to the display panel.

4. The image processing device according to claim 3, wherein the image data input from the image sensor are processed and transmitted in time to the display panel via the display panel controller.

5. The image processing device according to claim 1, wherein the time required for inputting the image data from image sensor into the image processing device is less than the time for outputting the image data from the display panel controller to the display panel, and the time required for inputting the image data corresponding to one line of image from the image sensor is not less than the time required for outputting the image data corresponding to one line of image from the display panel controller to the display panel.

6. The image processing device according to claim 5, wherein the memory space is not larger than the image data amount corresponding to one line of image on the display panel.

7. The image processing device according to claim 5, wherein the line blanking time between the image data corresponding to each line of image input from the image sensor is used for the display panel controller to transmit the image data to the display panel.
